(19) United States
(12) Patent Application Publication
(10) Pub. No.: US 2026/0281447 A1
(43) Pub. Date: Sep. 17, 2026

(54) ENCODING AND DECODING METHODS USING QUANTIZATION CONSTRAINED CORRECTION AND CORRESPONDING APPARATUSES

(71) Applicant: InterDigital CE Patent Holdings, SAS, Paris (FR)

(72) Inventors: Mikael LE PENDU, RENNES (FR); João Miguel PEREIRA DA SILVA SANTOS, RENNES (FR); Thierry DUMAS, RENNES (FR); Franck GALPIN, THORIGNE-FOUILLARD (FR)

(21) Appl. No.: 19/168,063

(22) PCT Filed: Mar. 13, 2024
(86) PCT No.: PCT/EP2024/056697

§ 371 Date: Sep. 23, 2025

(30) Foreign Application Priority Data
Mar. 24, 2023 (EP) 23305407.1
Oct. 18, 2023 (EP) 23306822.0

(51) Int. Cl. H04N 19/65; H04N 19/176; H04N 19/80

(52) U.S. Cl. CPC H04N 19/65; H04N 19/176; H04N 19/80

(57) ABSTRACT

A decoding method is disclosed. An image block is first reconstructed from decoded quantization levels and a prediction block. The reconstructed image block is filtered to obtain a filtered image block. Finally, a correction is applied on said filtered image block so that a quantization level obtained by quantizing a corrected prediction residual transform coefficient is equal to a corresponding decoded quantization level.

### CROSS REFERENCE TO RELATED APPLICATIONS

This application claims the benefit of European Application No. 23305407.1, filed on Mar. 24, 2023, and of European Application No. 23306822.0, filed on Oct. 18, 2023 which are incorporated herein by reference in their entirety.

### TECHNICAL FIELD

At least one of the present embodiments generally relates to a method and an apparatus for encoding and decoding a picture block using quantization constrained correction.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

In one implementation, a correction is applied on a reconstructed image block after at least one filtering to obtain a corrected image block. The correction is a quantization-constrained correction. In an example, the correction is such that a quantization level obtained by quantizing a corrected prediction residual transform coefficient is equal to a corresponding decoded quantization level.

### BRIEF DESCRIPTION OF THE DRAWINGS

FIG. 1 illustrates a block diagram of a system within which aspects of the present embodiments may be implemented;

FIG. 2 illustrates a block diagram of an embodiment of a video encoder;

FIG. 3 illustrates a block diagram of an embodiment of a video decoder;

FIG. 4A illustrates the quantization and dequantization of a transform coefficient;

FIG. 4B illustrates the quantization and dequantization of a transform coefficient;

FIGS. 5A and 5B depict flowcharts of a decoding method according to various embodiments;

FIG. 6A illustrates an example of a correction function;

FIG. 6B illustrates another example of a correction function;

FIGS. 7A and 7B depict flowcharts of an encoding method according to various embodiments;

FIG. 8 depicts a flowchart of a method for reconstructing an image block according to a specific embodiment; and

FIG. 9 depicts a flowchart of a method for correcting an image block after reconstruction and filtering according to a specific embodiment.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

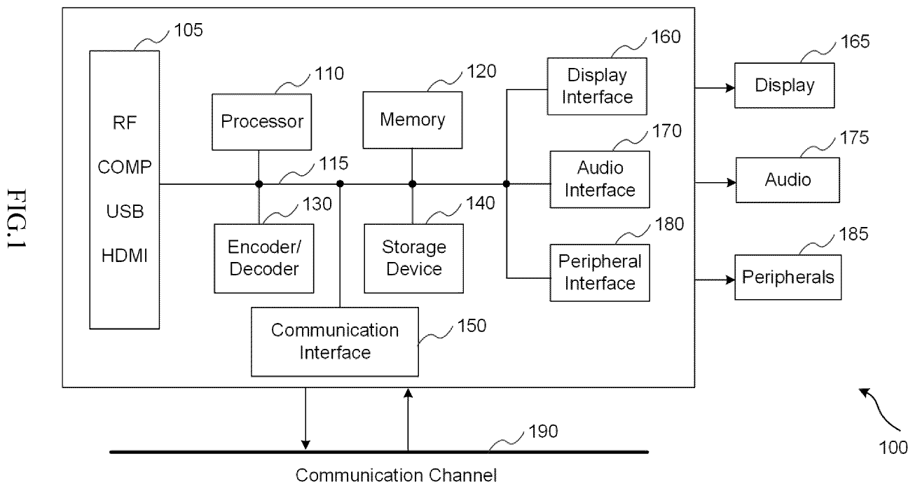

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “encoded” or “coded” may be used interchangeably, the terms “pixel” and “sample” may be used interchangeably and the terms “image,” “picture” and “frame” may be used interchangeably. Usually, but not necessarily, the term “reconstructed” is used at the encoder side while “decoded” is used at the decoder side. In the present application, the terms “dequantization” and “scaling” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

For the sake of clarity, satisfying, failing to satisfy a condition and configuring condition parameter(s) are described throughout embodiments described herein as relative to a threshold (e.g., greater, or lower than), a (e.g., threshold) value, configuring the (e.g., threshold) value, etc.). For example, satisfying a condition may be described as being above a (e.g., threshold) value, and failing to satisfy a condition (e.g., performance criteria) may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

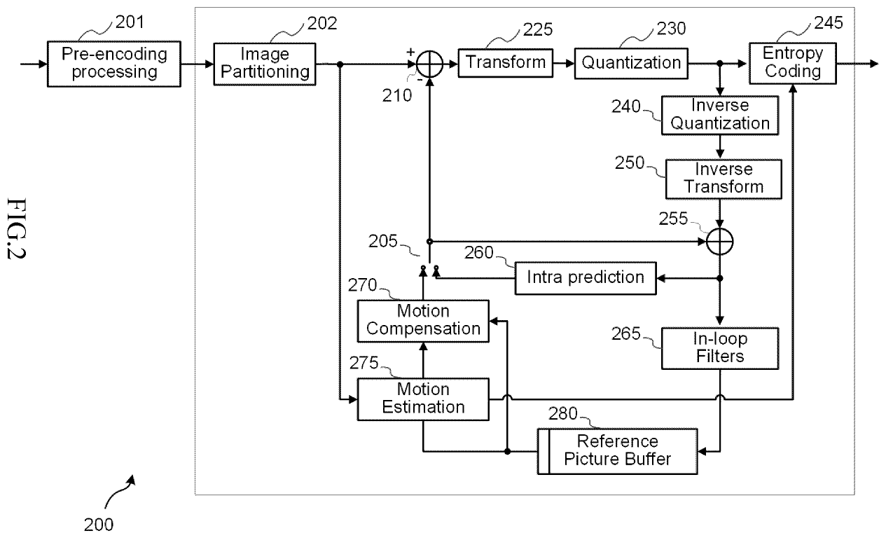

FIG. 2 illustrates an example video encoder 200, such as a VVC (Versatile Video Coding) encoder. FIG. 2 may also illustrate an encoder in which improvements are made to the VVC standard or an encoder employing technologies similar to VVC.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 200, a picture is encoded by the encoder elements as described below. The picture to be encoded is partitioned (202) and processed in units of, for example, CUs (Coding Units). Each unit is encoded using, for example, either an intra or inter mode. When a unit is encoded in an intra mode, it performs intra prediction (260), e.g. using an intra-prediction tool such as Decoder Side Intra Mode Derivation (DIMD). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block (a.k.a. prediction block) from the original image block.

The prediction residuals are then transformed (225) into transform coefficients c (a.k.a prediction residual transform coefficients) which are quantized (230) into quantization indexes c_{q} (a.k.a transform coefficient levels or quantized transform coefficients on the encoder side). The quantization levels (a.k.a quantization indexes) c_{q}, as well as motion vectors and other syntax elements such as the picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) (a.k.a. scaled) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280). In-loop filters (265) are thus used to enhance reconstructed images before storing them in the reference picture buffer (280). In-loop filters form a whole family. Among them, deblocking filters (DBF) aim at reducing blocking artifacts occurring along block boundaries. Deblocking filters are usually designed to improve subjective quality, that is, the noticeability of such coding errors by the human psychovisual system. In usual video coding standards such as HEVC and VVC, deblocking filters are predetermined based on coding information (such as prediction modes, motion vectors, transform coefficients) and on local variations across block boundaries. On the other hand, adaptive loop filters (ALF) are learnt at encoder side in order to minimize a mean squared error with respect to source images, then the learned filter weights are encoded into the bitstream. Adaptive loop filters are usually applied at CTU-level, while deblocking filters are applied along block borders.

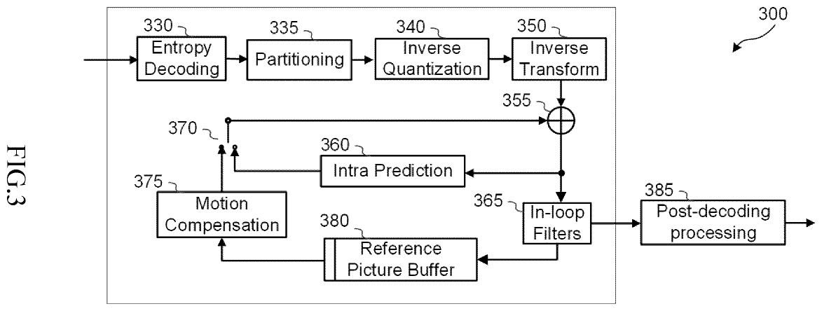

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain quantization levels c_{q} (a.k.a. transform coefficient levels or quantization levels on the decoder side), prediction modes, motion vectors, and other coded information. The picture partition information indicates how the picture is partitioned. The decoder may therefore divide (335) the picture according to the decoded picture partitioning information. The quantization levels c_{q} are de-quantized (340) into reconstructed transform coefficients cᵣ. De-quantization is also named scaling. The reconstructed transform coefficients cᵣ are inverse transformed (350) to obtain the prediction residuals. Combining (355) the prediction residuals and the predicted block (a.k.a. prediction block), an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder 300 side is identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

HEVC and VVC standards specify conventional independent scalar quantization with Uniform Reconstruction Quantizers (URQs). The reconstructed transform coefficients cᵣ of URQs are completely denoted by integer multiples of a quantization step size Δ (a.k.a. quantization step) which depends on a quantization parameter (QP). This integer specifies the associated transform coefficient level, which is transmitted in the bitstream as quantization levels c_{q}. On the decoder side, given a quantization level c_{q} and a quantization step size Δ, a reconstructed transform coefficient cᵣ may be generated as follows:

$${c}_{r} = {Q}^{- 1} ( {c}_{q} ) = {c}_{q} \times Δ \qquad ( 1 )$$

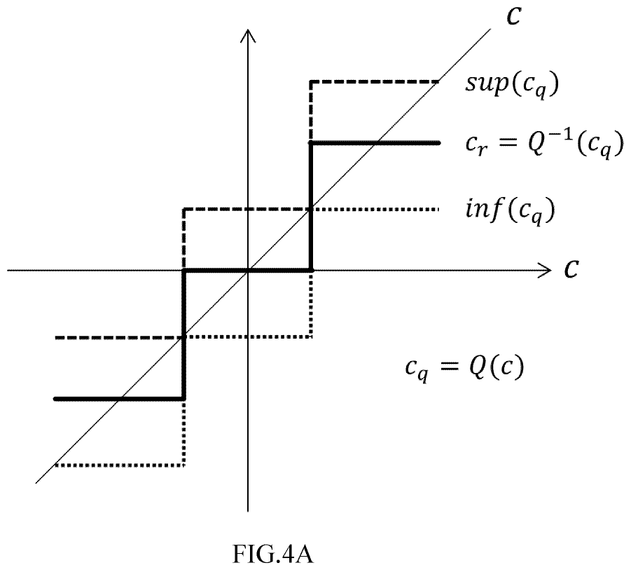

On the encoder side, given a coefficient c (a.k.a a transform coefficient or more precisely a prediction residual transform coefficient) and a quantization step size Δ, a quantization level c_{q} may be generated as follows:

$${c}_{q} = Q ( c ) = [ c / Δ ] \qquad ( 2 a )$$

where [.] is the rounding operation to the closest integer. By using this quantization, the quantization levels c_{q} which minimize the mean square error (MSE) between the original and the reconstructed signals is selected. Using these MSE optimal quantization levels c_{q} ensures that the original coefficient c is comprised between an inferior quantization bound inf_{Q}(c_{q}) and a superior quantization bound sup_{Q}(c_{q}) as illustrated by FIG. 4A. In the case of uniform quantization with quantization step size Δ, the inferior and superior quantization bounds are defined as follows:

$${inf}_{Q} ( {c}_{q} ) = {Q}^{- 1} ( {c}_{q} ) - \frac{Δ}{2} = ( {c}_{q} - \frac{1}{2} ) \times Δ \qquad ( 3 a )$$

$${sup}_{Q} ( {c}_{q} ) = {Q}^{- 1} ( {c}_{q} ) + \frac{Δ}{2} = ( {c}_{q} + \frac{1}{2} ) \times Δ \qquad ( 4 a )$$

In this case, the bounds may be computed by applying dequantization to the quantization level c_{q} summed with an offset −½ (for the inferior bound) or +½ (for the superior bound). However, a more general formula of the quantization may also be used by the encoder, resulting in different offsets to compute the quantization bounds. For example, the quantization may also be performed as follows:

$${c}_{q} = Q ( c ) = ⌊ abs ( c ) / Δ + a ⌋ \times sgn ( c ) \qquad ( 2 b )$$

where └.┘ is a floor operation (i.e. rounding to a lower integer), abs is an absolute value, sgn is the sign function (i.e. returns 1 if c>0, −1 if c<0 and 0 if c=0), and a is a parameter such that 0<a<1. Then the quantization bounds become:

$${inf}_{Q} ( {c}_{q} ) = \{ \begin{matrix}( {c}_{q} - {o}_{max} ) \times Δ & if {c}_{q} \leq 0 \\ ( {c}_{q} + {o}_{min} ) \times Δ & if {c}_{q} > 0\end{matrix} \qquad ( 3 b )$$

$${sup}_{Q} ( {c}_{q} ) = \{ \begin{matrix}( {c}_{q} - {o}_{min} ) \times Δ & if {c}_{q} < 0 \\ ( {c}_{q} + {o}_{max} ) \times Δ & if {c}_{q} \geq 0\end{matrix} \qquad ( 4 b )$$

with minimum offset oₘᵢₙ and maximum offset oₘₐₓ defined as oₘᵢₙ=−a and oₘₐₓ=1−a. This parameterization of the quantization bounds and reconstruction values is further illustrated in FIG. 4B. In this case, the inferior bound inf_{Q}(c_{q}) is thus obtained by applying dequantization to the quantization level c_{q} summed with an offset −oₘₐₓ if c_{q}≤0, or +oₘᵢₙ otherwise. The superior bound sup_{Q}(c_{q}) is obtained similarly using the offset −oₘᵢₙ if c_{q}<0, or +oₘₐₓ otherwise.

The encoder may use alternative strategies to select the quantization levels c_{q}. For example, rate distortion optimized quantization (RDOQ) optimizes the quantization levels accounting not only for the distortion (i.e., MSE), but also for the rate. In this case, it is no longer guaranteed that the original coefficients c are between the bounds inf_{Q}(c_{q}) and sup_{Q}(c_{q}).

In the following, c is assumed to be bounded by inf_{Q}(c_{q}) and sup_{Q}(c_{q}), where inf_{Q}(c_{q}) and sup_{Q}(c_{q}) can be determined on the decoder side knowing the quantization level c_{q}, the scalar quantizer Q (a.k.a. scalar quantization operation) and its quantization parameter (QP). If the encoder uses quantization strategies that may break this assumption, such as RDOQ, the method remains applicable.

Let us define a quantization constraint by the following equation:

$$Q ( {c}_{x} ) = {c}_{q} \qquad ( 5 )$$

where Q is a scalar quantization operation (a.k.a scalar quantizer), c_{q} is the quantization level of a prediction residual transform coefficient c, and cₓ is a reconstructed value of the corresponding transform coefficient c. When no in-loop or out-of-loop filter is applied to a reconstructed picture, each reconstructed transform coefficient cₓ is obtained as cₓ=cᵣ=Q⁻¹(c_{q}), which is between the quantization bounds inf(c_{q}) and sup(c_{q}) as depicted on FIG. 4A. Therefore, in this case, the quantization constraint Q(cᵣ)=c_{q} is satisfied. Assuming that each quantization level was determined by the encoder as c_{q}=Q(c), where c is the original (unquantized) coefficient, then Q(cᵣ)=Q(c), which is a necessary condition to reconstruct the original coefficient c without error. More generally, the absolute error |cᵣ−c| between a reconstructed coefficient and the corresponding original coefficient is such that 0≤|cᵣ−c|<sup_{Q}(c_{q})−inf_{Q}(c_{q}).

However, in the case of filtering the reconstructed picture (e.g., with DBF, SAO, ALF, etc.), the transform coefficients c_{f} of said reconstructed and filtered picture might not satisfy the above quantization constraint anymore, resulting in a loss of information. For example, the DBF filter improves the subjective quality by removing block discontinuities, but it may also remove some details in the filtered area at the borders of the blocks. As a result, for some coefficients, we may have c_{f}>sup_{Q}(c_{q}) or c_{f}<inf_{Q}(c_{q}), and thus Q(c_{f})≠c_{q}. Said otherwise, the quantization constraint is not necessarily satisfied. This results in a sub-optimal MSE of the filtered picture since the corresponding original coefficient c is expected to be in the range [sup_{Q}(c_{q}), inf_{Q}(c_{q})]. Thus, c_{f} is necessarily different from the original coefficient c (i.e. |c_{f}−c|>0), and the error |c_{f}−c| is not bounded by sup_{Q}(c_{q})−inf_{Q}(c_{q}). Although the ALF filter is designed to reduce the MSE between the original and the reconstructed and filtered picture, it does not guarantee that the quantization constraint Q(c_{f})=c_{q} is satisfied for every coefficient c_{f}, hence potentially leading to sub-optimal MSE given that the quantization levels c_{q} are known to both the encoder and the decoder.

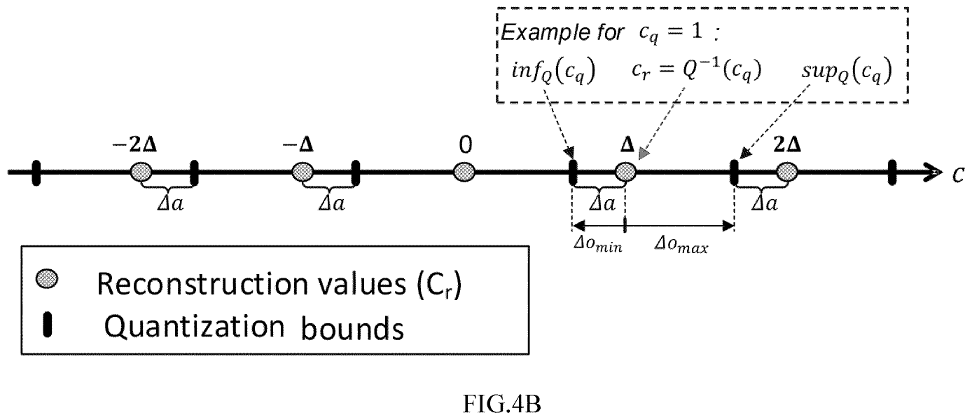

In contrast, a method for decoding is disclosed below with reference to FIGS. 5A and 5B that makes it possible to ensure a reduced distortion (e.g. an optimal MSE) between the original picture and the reconstructed and filtered picture by applying a correction (a.k.a quantization-constrained correction) on the prediction residual transform coefficients of the filtered picture. Said otherwise, applying a quantization-constrained correction on the prediction residual transform coefficients of the filtered picture according to the present principles ensures that the reconstructed and filtered picture is closer to the original picture in terms of MSE. The goal is to prevent the filters from losing information that could be inferred from the quantized transform coefficients signaled in the bitstream, while still preserving the filtering effect.

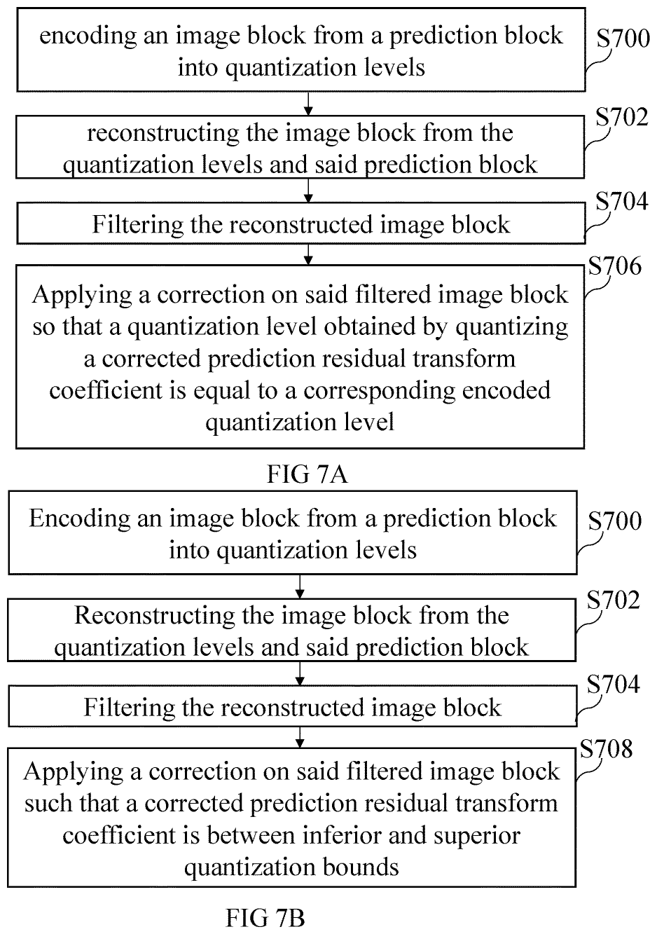

FIG. 5A depicts a flowchart of a decoding method according to a specific embodiment. At S500, an image block is reconstructed from decoded data, namely from quantization levels Cq and from a prediction block. The quantization levels Cq may be entropy decoded from encoded data (e.g. from a bitstream). The reconstruction step is further detailed in FIG. 8. At S502, the reconstructed image block is filtered by at least one in-loop filter, e.g. DBF, SAO, ALF, etc. The output of S502 is thus a filtered block (a.k.a filtered image block).

At S504, a correction is applied on the filtered block. More precisely, the correction is applied on the filtered block so that a quantization level obtained by quantizing a corrected prediction residual transform coefficient, i.e. a corrected transform coefficient of a prediction residual obtained from said filtered block, is equal to a corresponding decoded quantization level. The notion of correspondence relates to the position/location of the coefficient within the block.

FIG. 5B depicts a flowchart of the decoding method according to another embodiment. The steps that are identical to the steps depicted on FIG. 5A are identified by the same numeral references. In FIG. 5B, S504 is replaced by S506. A correction is applied on the filtered block. More precisely, the correction is applied on the filtered block such that a corrected prediction residual transform coefficient [symbol] is between inferior and superior quantization bounds inf(c_{q}) and sup(c_{q}).

The correction may be applied as an in-loop filter (i.e. a filter applied in the decoding loop) or as an out-of-loop filter (i.e. a filter applied out of the decoding loop, i.e., applied in a post-decoding processing step). In the case where, it is applied in-loop, a syntax element (e.g. a flag use_qc may be signaled per region (e.g., CTU, slice, picture, . . . ) to indicate if the correction is to be applied to the corresponding region. Said otherwise, the flag use_qc indicates for a given region it is associated with whether the correction is to be applied to the corresponding region.

Alternatively, the flag use_qc may be inferred and not signaled explicitly. For example, the correction may be performed depending on whether QP satisfies a condition. As an example, the correction may be performed in the case where QP is above a threshold. In another example, the correction may be performed only in the case where QP is above a threshold.

In another example, the correction is applied as an out-of-loop filter, i.e., in the post-decoding processing step (the modifications are not stored in the reference picture buffer). In this case the correction is applied after the in-loop filters. A SEI message may be signaled by the encoder to indicate if the correction should be applied to a given picture/slice.

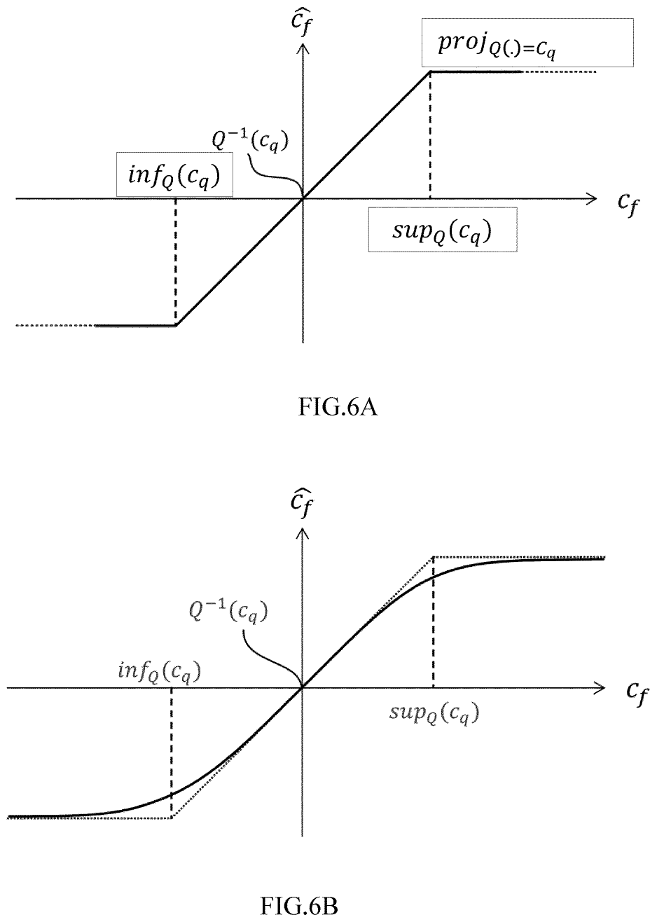

FIG. 7A depicts a flowchart of an encoding method according to a specific embodiment.

At S700, an image block is encoded from a prediction block into quantization levels, e.g. in a bitstream.

At S702, the encoded image block is reconstructed from the prediction block and the quantization levels to obtain a reconstructed image block. This step is identical to S500 and is further detailed in FIG. 8.

At S704, the reconstructed image block is filtered by at least one in-loop filter, e.g. DBF, SAO, ALF, etc. The output of S704 is thus a filtered block. This step is identical to S502.

At S706, a correction is applied on the filtered block. More precisely, the correction is applied on the filtered block so that a quantization level obtained by quantizing a corrected prediction residual transform coefficient, i.e. a corrected transform coefficient of a prediction residual obtained from said filtered block, is equal to a corresponding encoded quantization level. The notion of correspondence relates to the position/location of the coefficient within the block. This step is identical to S504.

FIG. 7B depicts a flowchart of the encoding method according to another embodiment. The steps that are identical to the steps depicted on FIG. 7A are identified by the same numeral references. In FIG. 7B, S706 is replaced by S708. A correction is applied on the filtered block. More precisely, the correction is applied on the filtered block such that a corrected prediction residual transform coefficient [symbol] is between inferior and superior quantization bounds inf(c_{q}) and sup(c_{q}). This step S708 is identical to S506.

When the correction is applied in-loop, a flag use_qc may be signaled per region (e.g., CTU, slice, picture, . . . ) to indicate if the correction is to be applied to the corresponding region. For example, the encoder may activate this flag if the MSE reduction obtained by the QC correction is above a value th:

$$use\_qc = \{ \begin{matrix}1 & if MSE ( {X}_{f} , X ) - MSE ( {X}_{QCF} , X ) > th \\ 0 & otherwise\end{matrix} \qquad ( 6 )$$

where X is the original signal.

Alternatively, the flag may be inferred and not signaled explicitly. For example, the QC correction may be performed depending on whether QP satisfies a condition. As an example, the QC correction may be performed in the case where QP is above a threshold. In another example, the QC correction may be performed only in the case where QP is above a threshold.

When the correction is applied out-of-loop, the value of the SEI message that indicates if the QC correction should be applied to a given picture/slice can be determined by the encoder in a similar way as described for the flag use_qc in Eq. (6).

In both the encoding method and decoding method, the QC correction is not meant to be used directly after the reconstruction if no filter was applied. In this case the QC correction is not expected to have any effect since a non-filtered reconstructed block already satisfies the quantization constraint that is enforced by the QC correction. Hence, in an example, the QC correction is applied as an in-loop filter, after at least one other in-loop filter. In one variant, the QC correction is applied as the last in-loop filter. However, the ALF filter is usually the last in-loop filter since the weight of the convolution filters used in ALF are optimized on the encoder side to minimize the error between the original picture and the ALF-filtered reconstructed pictured, without considering further correction steps in the optimization. Therefore, in a preferred variant, the QC correction step is applied before ALF, but after other filters. In another variant, the QC correction is applied before the SAO filter but after the DBF filter.

FIG. 8 depicts a flowchart of a method for reconstructing an image block according to a specific embodiment.

At step S800, quantization levels c_{q} of a current block are dequantized to obtain reconstructed coefficients cᵣ=Q⁻¹(c_{q}). Each quantization level c_{q} is assigned a position within the current block. The quantization levels c_{q} may be obtained by entropy decoding encoded data representative of the image block to be reconstructed. In an example, the dequantization is a scalar dequantization by a dequantization function Q⁻¹ which is parameterized by a quantization parameter QP.

At step S802, an inverse transform T⁻¹ is applied to the reconstructed coefficients cᵣ in order to obtain a prediction residual block.

At step S804, an image block Xᵣ is reconstructed as the sum of the prediction residual block obtained at step S802 and a prediction block pred. As mentioned with reference to FIG. 2, the prediction block pred may be obtained by intra prediction or motion compensation of pictures in the reference picture buffer.

At step S806, the reconstructed block Xᵣ may be filtered. The filters may be of various types, e.g. a deblocking filter, SAO, ALF, etc. The filtered block is denoted X_{f}.

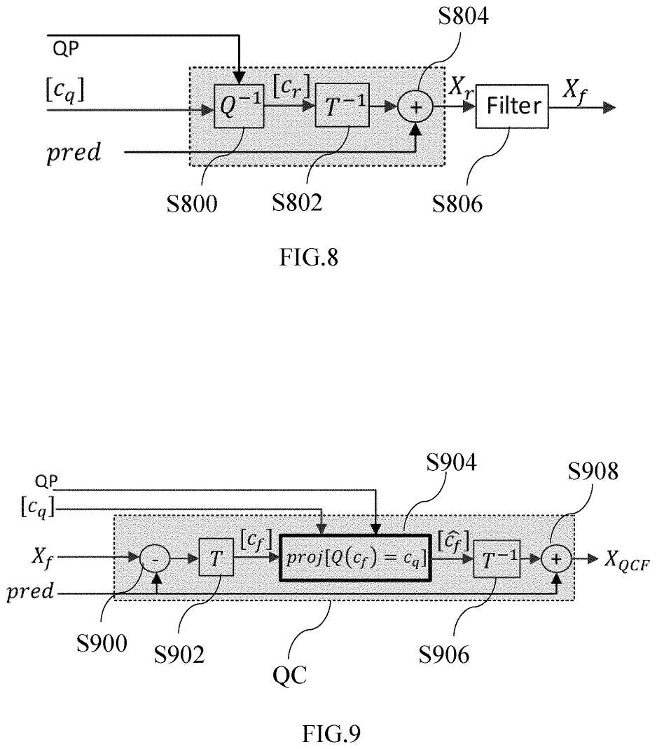

FIG. 9 depicts a flowchart of a method for correcting an image block after reconstruction and filtering according to a specific embodiment. The correction, also called quantization constrained correction and denoted QC, is applied to the image block X_{f}. The correction QC first converts X_{f} at S900 back to prediction residuals and compute its transform coefficients c_{f} at S902 in order to correct the values of these coefficients using a correction step S904 that ensures that the quantization constraint Q( [symbol] )=c_{q} is satisfied for the corrected coefficient [symbol] . The corrected coefficients [symbol] are then converted back at S906 to obtain the corrected block X_{QCF} using the inverse transform T⁻¹ and the summation with the prediction block at S910. The steps of the correction QC are further detailed hereafter:

At S900, X_{f} is converted back to prediction residuals. To this aim, the prediction block pred is subtracted from the filtered image block X_{f} in order to obtain a prediction residual block (e.g. also called filtered prediction residual block). The prediction pred is equal to the prediction used at S804 in the reconstruction stage depicted on FIG. 8. Therefore, the prediction block pred does not have to be computed again using the codec's prediction mechanisms. Instead, the prediction block may be stored in a buffer during the reconstruction and reused for the QC correction.

At S902, the (e.g. filtered) prediction residual block is then converted back to the transform domain using the forward transform T. In the case where several types of transforms or inverse transforms may be applied (e.g., DCT-II, DST-7, DCT-8), the QC correction uses the forward transform T of the same type as the inverse transform T⁻¹ used at S802 during the reconstruction stage. For example, if a block X is reconstructed using the inverse of the DCT-II at S802, its corresponding block (i.e. the block of coefficients c_{f} obtained from X) in the QC correction is transformed with forward DCT-II. The forward transform thus produces a new block of prediction residual transform coefficients c_{f}, named more simply transform coefficients c_{f}, each located at a given position within the block. Each transform coefficient c_{f} can thus be associated with the quantization level c_{q} used during the reconstruction stage, and which is located at the same position within the block.

At S904, each transform coefficient c_{f} of the block of prediction residual transform coefficients is corrected to obtain a block of corrected prediction residual transform coefficients [symbol] named more simply corrected transform coefficient [symbol] . Its corrected version [symbol] is computed as [symbol] =proj_{[Q(.)=c}_{_{q}}_{]}(c_{f}), where proj_{[Q(.)=c}_{_{q}}_{]} is a correction function (also called projection function onto the quantization constraint). This correction function ensures that the constraint Q( [symbol] )=c_{q} is satisfied, where c_{q} is the quantization level associated with c_{f}, and where Q is the scalar quantizer associated with the scalar dequantizer Q⁻¹ used in the reconstruction stage at S800. The correction function can be defined as follows:

$${proj}_{[ Q ( . ) = {c}_{q} ]} ( {c}_{f} ) = min ( max ( {c}_{f} , {inf}_{Q} ( {c}_{q} ) ) , {sup}_{Q} ( {c}_{q} ) ) \qquad ( 7 )$$

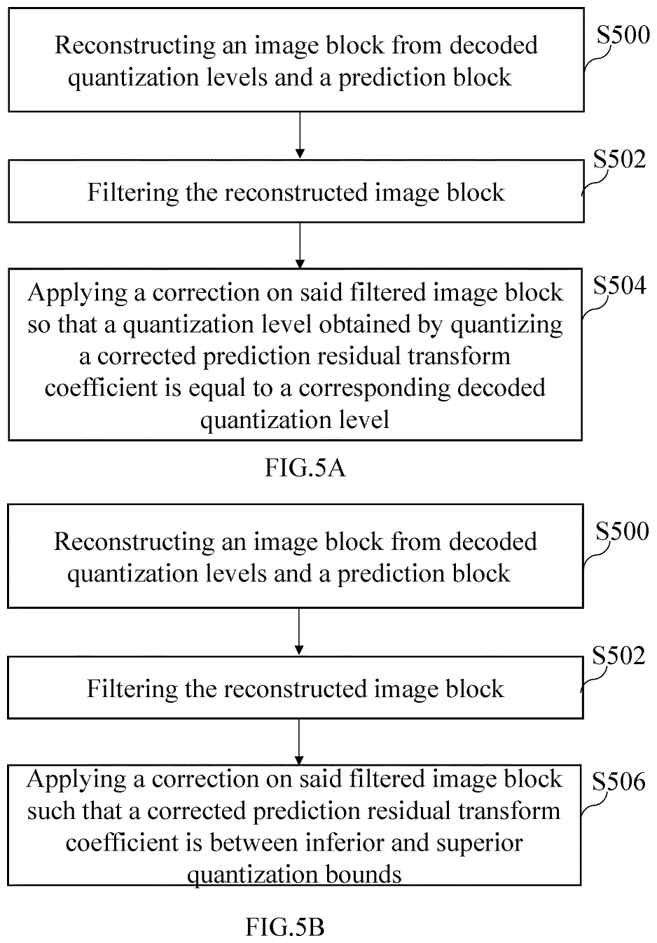

This function is illustrated on FIG. 6A. With this definition, each corrected transform coefficient [symbol] is always between the quantization bounds inf_{Q}(c_{q}) and sup_{Q}(c_{q}) of the quantization level c_{q} for the quantizer Q. Hence [symbol] satisfies Q( [symbol] )=c_{q}. However, if c_{f} is already within the quantization bounds, no correction is applied (i.e. [symbol] =c_{f}), which preserves the filtering effect.

The correction function in Eq.7 is defined to enforce the quantization constraint while also minimizing the squared error ( [symbol] −c_{f})² between the corrected and the uncorrected coefficient. However, other functions may be used. For example, a more general clipping function can be defined as [symbol] =min(max (c_{f}, bₘᵢₙ), bₘₐₓ) with clipping bounds bₘᵢₙ, bₘₐₓ. Taking clipping bounds such that inf_{Q}(c_{q})<bₘᵢₙ<bₘₐₓ<sup_{Q}(c_{q}), still ensures that the constraint Q( [symbol] )=c_{q} is satisfied (since inf_{Q}(c_{q})<bₘᵢₙ≤ [symbol] ≤bₘₐₓ<sup_{Q}(c_{q})). For example, clipping bounds bₘᵢₙ and bₘₐₓ may be computed similarly to inf_{Q}(c_{q}) and sup_{Q}(c_{q}) using Eqs. 3b and 4b respectively, but using the parameters oₘᵢₙ and oₘₐₓ that are not necessarily set as oₘᵢₙ=−a and oₘₐₓ=1−a. Note that using oₘᵢₙ and oₘₐₓ such that −a≤oₘᵢₙ<oₘₐₓ≤1−a ensures that inf_{Q}(c_{q})≤bₘᵢₙ<bₘₐₓ≤sup_{Q}(c_{q}). Hence, assuming that c_{q} is computed with the quantization function in Eq. 2b by the encoder, it ensures that the constraint Q( [symbol] )=c_{q} is satisfied. If other quantization methods are used by the encoder (e.g., RDOQ), it may be difficult to enforce the constraint Q( [symbol] )=c_{q} in practice (e.g., the quantization Q may be computationally extensive, or may involve many parameters that are unknown to the decoder). Hence, for simplicity in such cases, we may still define the correction function as a clipping function between bounds bₘᵢₙ and bₘₐₓ, which enforces the simpler constraint bₘₐₓ≤ [symbol] ≤bₘᵢₙ. However, in rate-distortion based quantization methods such as RDOQ, the original coefficient may not be between the bounds inf_{Q} (c_{q}) and sup_{Q}(c_{q}) defined in Eqs. 3b and 4b. Hence, we may compute the clipping bounds bₘᵢₙ, bₘₐₓ using parameters oₘᵢₙ and oₘₐₓ that do not necessarily satisfy the condition −a≤oₘᵢₙ<oₘₐₓ≤1−a.

In another example, a smooth version of the correction function proj_{[Q(.)=c}_{_{q}}_{]} may be used such as:

$$\hat{{c}_{f}} = s \cdot tan h ( \frac{{c}_{f} - o}{s} ) + o , \qquad ( 8 )$$

with a scale

$$s = \frac{{sup}_{Q} ( {c}_{q} ) - {inf}_{Q} ( {c}_{q} )}{2}$$

and an offset

$$o = \frac{{sup}_{Q} ( {c}_{q} ) + {inf}_{Q} ( {c}_{q} )}{2} .$$

This smooth function is illustrated by FIG. 6B. Similarly to the previous example, the clipping bounds bₘᵢₙ and bₘₐₓ may be used instead of the inferior and superior bounds inf_{Q}(c_{q}) and sup_{Q} (c_{q}) respectively for the computation of the scale and offset parameters o and s.

After enforcing the quantization-constraint in the residual transform domain, the corrected transform coefficients [symbol] are converted back to the image domain to obtain a final corrected image block X_{QCF}. This is performed by first applying the inverse transform again at S906 to obtain a block of corrected prediction residuals. The same inverse transform T⁻¹ is used as in the reconstruction stage at S802. Finally, at S908, the prediction block pred is added back to the block of corrected prediction residuals to obtain a corrected image block X_{QCF} which satisfies the quantization constraint.

Moreover, the present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, correcting a filtered image block.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, correcting a filtered image block.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated with a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals quantization levels. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

In an example, a decoding method is disclosed that comprises:
reconstructing an image block from decoded quantization levels and a prediction block; filtering the reconstructed image block to obtain a filtered image block; and
applying a correction on the filtered image block so that a quantization level obtained by quantizing a corrected prediction residual transform coefficient is equal to a corresponding decoded quantization level.

In an example, an encoding method is disclosed that comprises:
encoding an image block from a prediction block into quantization levels;
reconstructing an image block from the quantization levels and the prediction block; filtering the reconstructed image block to obtain a filtered image block; and
applying a correction on the filtered image block so that a quantization level obtained by quantizing a corrected prediction residual transform coefficient is equal to a corresponding encoded quantization level.

The following embodiments apply to both the decoding and encoding methods.

In an example, applying a correction on the filtered image block comprises:
obtaining a block of prediction residual transform coefficients from the filtered image block; applying a correction function on each prediction residual transform coefficient of the block to obtain a block of corrected prediction residual transform coefficients, the correction function being such that a quantization level obtained by quantizing a corrected prediction residual transform coefficient is equal to a corresponding decoded (encoded respectively) quantization level; and
obtaining a corrected image block from the block of corrected prediction residual transform coefficients.

In an example, obtaining a block of prediction residual transform coefficients from the filtered image block comprises:
subtracting the prediction block from the filtered image block to obtain a prediction residual block; and
transforming the prediction residual block into a block of prediction residual transform coefficients.

In an example, obtaining a corrected image block from the block of corrected prediction residual transform coefficients comprises:
inverse transforming the block of corrected prediction residual transform coefficients to obtain a block of corrected prediction residuals; and
adding the prediction block to the block of corrected prediction residuals.

In an example, the correction function is defined as follows:
min(max (c_{f}, inf_{Q}(c_{q})), sup_{Q}(c_{q})), where c_{f} is the prediction residual transform coefficient, c_{q} is the corresponding decoded (encoded respectively) quantization level, inf_{Q}(c_{q}) is an inferior quantization bound and sup_{Q}(c_{q}) is a superior quantization bound.

In an example, the method further comprises obtaining an indicator for an image region comprising the image block, wherein the indicator indicates whether a correction applies to the image region.

In an example, obtaining the indicator comprises decoding (encoding respectively) a syntax element for the image region indicating whether the correction applies to the image region.

In an example, obtaining the indicator comprises determining whether a quantization parameter for the image region is above a value.

In an example, obtaining the indicator comprises decoding (encoding respectively) an SEI message indicating whether the correction applies to the image region.

A decoding apparatus is disclosed that comprises one or more processors and at least one memory coupled to the one or more processors, wherein the one or more processors are configured to perform the decoding method according any one of the various embodiments.

An encoding apparatus is disclosed that comprises one or more processors and at least one memory coupled to the one or more processors, wherein the one or more processors are configured to perform the encoding method according any one of the various embodiments.

A computer program is disclosed that comprises program code instructions for implementing the method according to any one of the various embodiments of the decoding or encoding method.

1. A decoding method comprising:
reconstructing an image block from decoded quantization levels and a prediction block;
filtering the reconstructed image block to obtain a filtered image block; and
applying a correction function on the filtered image block wherein the correction function is defined as min(max(c_{f}, bmin), bmax), where:
$$bmin = \{ \begin{matrix}( {c}_{q} - {o}_{max} ) \times Δ & if {c}_{q} \leq 0 \\ ( {c}_{q} + {o}_{min} ) \times Δ & if {c}_{q} > 0\end{matrix}$$
$$bmax = \{ \begin{matrix}( {c}_{q} - {o}_{min} ) \times Δ & if {c}_{q} < 0 \\ ( {c}_{q} + {o}_{max} ) \times Δ & if {c}_{q} \geq 0\end{matrix}$$
c_{f} is a prediction residual transform coefficient,
c_{q} is a corresponding decoded quantization level,
oₘᵢₙ and oₘₐₓ are minimum and maximum offset parameters, and
oₘₐₓ is different from oₘᵢₙ+1, Δ is a quantization step size.

2. The method of claim 1, wherein applying the correction function on the filtered image block comprises:
obtaining a block of prediction residual transform coefficients from the filtered image block;
applying the correction function on each prediction residual transform coefficient of the block to obtain a block of corrected prediction residual transform coefficients; and
obtaining a corrected image block from the block of corrected prediction residual transform coefficients.

3. The method of claim 2, wherein obtaining a block of prediction residual transform coefficients from the filtered image block comprises:
subtracting the prediction block from the filtered image block to obtain a prediction residual block; and
transforming the prediction residual block into a block of prediction residual transform coefficients.

4. The method of claim 2, wherein obtaining a corrected image block from the block of corrected prediction residual transform coefficients comprises:
inverse transforming the block of corrected prediction residual transform coefficients to obtain a block of corrected prediction residuals; and
adding the prediction block to the block of corrected prediction residuals.

5. (canceled)

6. The method of claim 1, further comprising obtaining an indicator for an image region comprising the image block, wherein the indicator indicates whether the correction function applies to the image region.

7-9. (canceled)

10. An encoding method comprising:
encoding an image block from a prediction block into quantization levels;
reconstructing the image block from the quantization levels and the prediction block;
filtering the reconstructed image block to obtain a filtered image block; and
applying a correction function on the filtered image block, wherein the correction function is defined as min(max(c_{f}, bmin), bmax), where
$$bmin = \{ \begin{matrix}( {c}_{q} - {o}_{max} ) \times Δ & if {c}_{q} \leq 0 \\ ( {c}_{q} + {o}_{min} ) \times Δ & if {c}_{q} > 0\end{matrix} ,$$
$$bmax = \{ \begin{matrix}( {c}_{q} - {o}_{min} ) \times Δ & if {c}_{q} < 0 \\ ( {c}_{q} + {o}_{max} ) \times Δ & if {c}_{q} \geq 0\end{matrix} ,$$
c_{f} is a prediction residual transform coefficient,
c_{q} is a corresponding decoded quantization level,
oₘᵢₙ and oₘₐₓ are minimum and maximum offset parameters, and
oₘₐₓ is different from oₘᵢₙ+1, Δ is a quantization step size.

11. The method of claim 10, wherein applying the correction function on the filtered image block comprises:
obtaining a block of prediction residual transform coefficients from the filtered image block;
applying the correction function on each prediction residual transform coefficient of the block to obtain a block of corrected prediction residual transform coefficients; and
obtaining a corrected image block from the block of corrected prediction residual transform coefficients

12. The method of claim 11, wherein obtaining a block of prediction residual transform coefficients from the filtered image block comprises:
subtracting the prediction block from the filtered image block to obtain a prediction residual block; and
transforming the prediction residual block into a block of prediction residual transform coefficients.

13. The method of claim 11, wherein obtaining a corrected image block from the block of corrected prediction residual transform coefficients comprises:
inverse transforming the block of corrected prediction residual transform coefficients to obtain a block of corrected prediction residuals; and
adding the prediction block to the block of corrected prediction residuals.

14. (canceled)

15. The method of claim 10, further comprising obtaining an indicator for an image region comprising the image block, wherein the indicator indicates whether the correction function applies to the image region.

16-22. (canceled)

23. A decoding apparatus comprising one or more processors and at least one memory coupled to the one or more processors, wherein the one or more processors are configured to perform:
reconstructing an image block from decoded quantization levels and a prediction block;
filtering the reconstructed image block to obtain a filtered image block; and
applying a correction function on the filtered image block, wherein the correction function is defined as min(max(c_{f}, bmin), bmax), where:
$$bmin = \{ \begin{matrix}( {c}_{q} - {o}_{max} ) \times Δ & if {c}_{q} \leq 0 \\ ( {c}_{q} + {o}_{min} ) \times Δ & if {c}_{q} > 0\end{matrix} ,$$
$$bmax = \{ \begin{matrix}( {c}_{q} - {o}_{min} ) \times Δ & if {c}_{q} < 0 \\ ( {c}_{q} + {o}_{max} ) \times Δ & if {c}_{q} \geq 0\end{matrix} ,$$
c_{f} is a prediction residual transform coefficient,
c_{q} is a corresponding decoded quantization level,
oₘᵢₙ and oₘₐₓ are minimum and maximum offset parameters, and
oₘₐₓ is different from oₘᵢₙ+1, Δ is a quantization step size.

24. The decoding apparatus of claim 23, wherein applying the correction function on the filtered image block comprises:
obtaining a block of prediction residual transform coefficients from the filtered image block;
applying the correction function on each prediction residual transform coefficient of the block to obtain a block of corrected prediction residual transform coefficients; and
obtaining a corrected image block from the block of corrected prediction residual transform coefficients.

25. The decoding apparatus of claim 24, wherein obtaining a block of prediction residual transform coefficients from the filtered image block comprises:
subtracting the prediction block from the filtered image block to obtain a prediction residual block; and
transforming the prediction residual block into a block of prediction residual transform coefficients.

26. The decoding apparatus of claim 24, wherein obtaining a corrected image block from the block of corrected prediction residual transform coefficients comprises:
inverse transforming the block of corrected prediction residual transform coefficients to obtain a block of corrected prediction residuals; and
adding the prediction block to the block of corrected prediction residuals.

27. The decoding apparatus of claim 23, wherein the one or more processors are further configured to perform obtaining an indicator for an image region comprising the image block, wherein the indicator indicates whether the correction function applies to the image region.

28. An encoding apparatus comprising one or more processors and at least one memory coupled to the one or more processors, wherein the one or more processors are configured to perform:
encoding an image block from a prediction block into quantization levels;
reconstructing the image block from the quantization levels and the prediction block;
filtering the reconstructed image block to obtain a filtered image block; and
applying a correction function on the filtered image block, wherein the correction function is defined as min(max(c_{f}, bmin), bmax), where:
$$bmin = \{ \begin{matrix}( {c}_{q} - {o}_{max} ) \times Δ & if {c}_{q} \leq 0 \\ ( {c}_{q} + {o}_{min} ) \times Δ & if {c}_{q} > 0\end{matrix} ,$$
$$bmax = \{ \begin{matrix}( {c}_{q} - {o}_{min} ) \times Δ & if {c}_{q} < 0 \\ ( {c}_{q} + {o}_{max} ) \times Δ & if {c}_{q} \geq 0\end{matrix} ,$$
c_{f} is a prediction residual transform coefficient,
c_{q} is a corresponding decoded quantization level,
oₘᵢₙ and oₘₐₓ are minimum and maximum offset parameters, and
oₘₐₓ is different from oₘᵢₙ+1, Δ is a quantization step size.

29. The encoding apparatus of claim 28, wherein applying the correction function on the filtered image block comprises:
obtaining a block of prediction residual transform coefficients from the filtered image block;
applying the correction function on each prediction residual transform coefficient of the block to obtain a block of corrected prediction residual transform coefficients; and
obtaining a corrected image block from the block of corrected prediction residual transform coefficients

30. The encoding apparatus of claim 29, wherein obtaining a block of prediction residual transform coefficients from the filtered image block comprises:
subtracting the prediction block from the filtered image block to obtain a prediction residual block; and
transforming the prediction residual block into a block of prediction residual transform coefficients.

31. The encoding apparatus of claim 29, wherein obtaining a corrected image block from the block of corrected prediction residual transform coefficients comprises:
inverse transforming the block of corrected prediction residual transform coefficients to obtain a block of corrected prediction residuals; and
adding the prediction block to the block of corrected prediction residuals.

32. The encoding apparatus of claim 28, wherein the one or more processors are further configured to perform obtaining an indicator for an image region comprising the image block, wherein the indicator indicates whether the correction function applies to the image region.
